(19) United States
(12) Patent Application Publication
(10) Pub. No.: US 2025/0342229 A1
(43) Pub. Date: Nov. 6, 2025

(54) CONTEXT-AWARE AUTOMATED FEATURE ENGINEERING USING LARGE LANGUAGE MODELS

(71) Applicant: Prior Labs GmbH, Freiburg (DE)

(72) Inventor: Noah Hollmann, Berlin (DE)

(21) Appl. No.: 19/198,387

(22) Filed: May 5, 2025

Related U.S. Application Data
(60) Provisional application No. 63/642,695, filed on May 4, 2024.

(51) Int. Cl. G06F 18/213; G06F 40/40

(52) U.S. Cl. CPC G06F 18/213; G06F 40/40

(57) ABSTRACT

This disclosure pertains to a system and method for automated feature engineering using language models, referred to herein as Context-Aware Automated Feature Engineering (CAAFE). The techniques may involve inputting a tabular dataset along with a context description and then enabling iterative feature generation using a large language model (LLM). The language model may receive inputs comprising a natural language description of the dataset and prediction task. During an iterative loop feedback process, automatically generated features that enhance performance above a specified threshold may be retained, while features below the specified threshold may be discarded, thereby fostering an iterative refinement and enrichment of the dataset with context-aware, semantically meaningful features. This automated approach significantly enhances model accuracy and expedites the integration of complex patterns and domain expertise into feature engineering, while also reducing the computational overhead required in the automated feature generation process.

### TECHNICAL FIELD

This disclosure is related generally to the field of Automated Machine Learning (AutoML), which is crucial for reducing human intervention in machine learning (ML) pipelines, and, more particularly, to the field of automated feature engineering.

### BACKGROUND

Various advancements in AutoML have sought to automate feature engineering in recent years. For example, some approaches have leveraged an automated system that relies on reinforcement learning to generate features, while other approaches have used predefined transformation rules. While such approaches do aim to automate the feature generation process to an extent, they tend to generate features that lack contextual relevance and/or fail to encapsulate the nuances needed for specific applications. Furthermore, these types of approaches cannot effectively integrate semantic and domain-specific knowledge, thereby leading to the generation of less predictive and interpretable features. Such approaches may also suffer from high computational demands, making them impractical for large-scale applications—and less adaptable across varied data types and prediction tasks without significant retooling.

Large Language Models (LLMs), e.g., GPT-3, GPT-4, and the like, have shown remarkable capabilities in natural language processing (NLP) and could potentially extend the scope of AutoML to cover more sophisticated data science tasks. However, their application in feature engineering has been limited to date and not fully explored for context-aware capabilities. For example, existing applications of LLMs in this domain lack the ability to deeply understand and integrate the context of the data that they are processing.

Thus, there is a need for systems and solutions that are capable of harnessing the generative and interpretive strengths of LLMs to automate feature engineering in an intelligent and contextually-aware manner.

### SUMMARY

Accordingly, several embodiments of the present invention provide systems and methods of providing LLMs with natural language descriptions of datasets, thereby enabling the automated generation of semantically meaningful features that are deeply tailored to the specific characteristics and needs of the data. Further embodiments disclosed herein provide an iterative validation process, wherein features are repeatedly evaluated and only are retained based on their actual impact on model performance, thereby ensuring the relevance and effectiveness of the automatically generated features. The techniques disclosed herein may, thus, not only reduce computational overhead—but also ensure that the generated features are both predictive and interpretable, which fulfills a critical need for efficiency and domain adaptability in feature engineering.

According to some embodiments, a system for automated feature engineering is disclosed, comprising: a language model configured to generate instructions for defining new data features for an input dataset based on a prompt; a validation module configured to execute the instructions generated by the language model to evaluate and retain one or more new data features for the input dataset; and an iterative feedback loop configured to revise the input dataset with the retained new data features and recursively provide the revised dataset as a new input dataset to the language model, wherein the new data feature definition process is repeated iteratively until a specified performance improvement threshold is no longer met.

According to other embodiments, the prompt is a context-aware prompt.

According to other embodiments, the prompt encapsulates a natural language description comprising one or more of: input dataset characteristics, a prediction objective, or domain-specific knowledge related to the input dataset.

According to other embodiments, the language model is based on any pre-trained model capable of processing and generating natural language instructions.

According to other embodiments, the evaluation of the one or more new data features is based, at least in part, on an effect of the one or more new data features on a performance of a data processing model. According to some such embodiments, the data processing model comprises one or more of: a statistical model; a machine learning model; or a deep learning network.

According to other embodiments, the validation module is further configured to retain new data features based, at least in part, on a performance improvement criterion being met. According to some such embodiments, the performance improvement criterion comprises one or more of: a statistical metric; or a machine learning performance metric.

According to further embodiments, a non-transitory program storage device (NPSD) is disclosed, comprising instructions stored thereon that, when executed, cause a computer to perform any of the various techniques enumerated above in this Section.

According to yet further embodiments, computer-implemented methods for automated feature engineering a system are disclosed, comprising performance of any of the various techniques enumerated above in this Section.

### BRIEF DESCRIPTION OF THE DRAWINGS

The present application is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In the drawings:

FIG. 1 illustrates an exemplary context-aware automated feature engineering (CAAFE) system that utilizes LLMs and an iterative feedback loop, according to one or more embodiments of the present disclosure.

FIG. 2 illustrates a table comparing the performance of a CAAFE system across various datasets, according to one or more embodiments of the present disclosure.

FIG. 3 illustrates a table comparing a CAAFE system with existing feature engineering methods, according to one or more embodiments of the present disclosure.

FIG. 4 illustrates a flow chart of an exemplary method for using a CAAFE system, according to one or more embodiments of the present disclosure.

FIG. 5 illustrates various efficiency metrics of a CAAFE system over iterative steps, according to one or more embodiments of the present disclosure.

FIG. 6 illustrates a simplified functional block diagram of an illustrative multifunctional electronic device, according to one or more embodiments of the present disclosure.

Aspects of the disclosure will now be described in detail with reference to the drawings, wherein like reference numbers refer to like elements throughout, unless specified otherwise.

### DETAILED DESCRIPTION OF ILLUSTRATIVE EMBODIMENTS

As introduced above, this disclosure pertains to the field of automated machine learning (AutoML), focusing specifically on the enhancement of automated feature engineering processes. Feature engineering, that is, the method by which raw data is transformed into formats that are more amenable to machine learning models, is critical for improving the accuracy and efficiency of predictive modeling.

Despite its importance, feature engineering remains one of the most labor-intensive aspects of model development, often requiring significant domain expertise and often becoming a bottleneck in the machine learning pipeline. Traditionally, feature engineering has been a manual task, performed by data scientists who leverage their domain knowledge to create meaningful features. This process, while effective, is inherently slow and scales poorly with the increasing size and complexity of data. Automated feature engineering has emerged as a solution to these challenges, aiming to reduce human labor by automatically generating and selecting features.

Early efforts in AutoML made strides by using reinforcement learning and deep learning techniques to automate the generation of features. These earlier systems, however, often lacked the ability to incorporate contextual nuances and domain-specific knowledge effectively into the feature generation process, leading to suboptimal performance and high computational costs.

Large language models (LLMs), such as the GPT-3 and GPT-4 family of models, have demonstrated remarkable capabilities in understanding and generating human language, suggesting potential applicability beyond simple text processing tasks. Despite these capabilities, the use of LLMs in automating feature engineering—particularly in a way that leverages their understanding of context and domain specificity—remains underexplored.

Thus, the techniques described herein utilize LLMs to automate the feature engineering process in a context-aware manner. That is, by providing these language models with a natural language description of the dataset, and then iteratively refining discovered features based on model performance, the techniques described herein enable the discovery of predictive and interpretable features that are closely aligned with the specific needs of the dataset and the task at hand. The approaches described herein may not only enhance the effectiveness of feature engineering but also reduce their computational overhead, thereby addressing the critical bottlenecks in traditional and existing AutoML methodologies.

### A Context-Aware Automated Feature Engineering (CAAFE) System Using Large Language Models (LLMs) and Iterative Empirical Validation

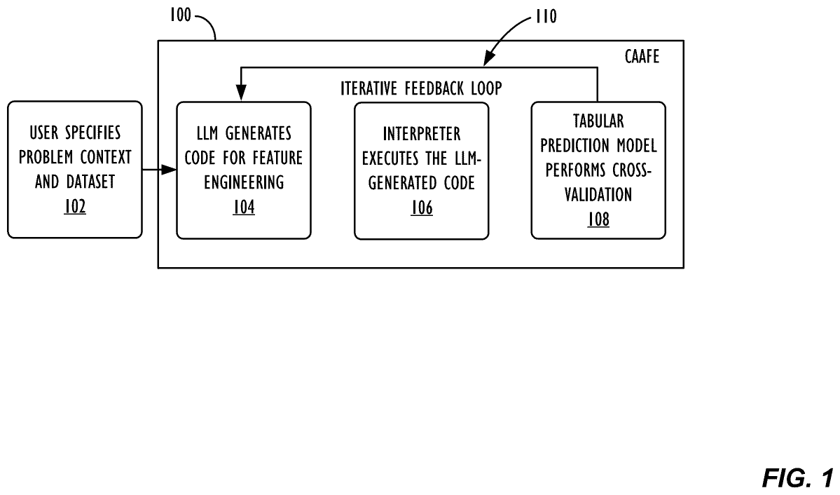

Turning now to FIG. 1, an exemplary CAAFE system 100 that utilizes LLMs and an iterative feedback loop is illustrated, according to one or more embodiments of the present disclosure. As will be described in further detail below, CAAFE system 100 is configured to progressively augment a dataset with features generated by the language model(s). The validated features may be retained based on their performance enhancement, and the enriched dataset may subsequently be re-input into the language model for further feature generation. This iterative validation cycle may continue until the improvements fall below a specified threshold, thereby enabling the discovery of complex and hierarchical feature combinations. For example, discovered features may build upon each other, i.e., in subsequent iterations, resulting in more and more complex features being built. For example, in a first iteration, a feature may be generated that extracts a city name from available location coordinates data; whereas the second iteration may then provide additional relevant information related to the extracted city information, and so forth.

CAAFE system 100 utilizes large language models (LLMs) to significantly enhance the field of automated machine learning (AutoML). By leveraging the generative capabilities of LLMs, CAAFE system 100 may create new, and more contextually-relevant features based on a natural language description of the dataset, prediction task, and domain knowledge.

At block 102, a user may provide the language model with a dataset, such as a tabular or otherwise structured dataset (e.g., structured into rows related to data entities and columns for the feature values related thereto), as well as a comprehensive natural language context description detailing the dataset's characteristics, the prediction task or problem at hand, and/or associated domain knowledge. Providing the language model with a tabular dataset and a comprehensive natural language context description detailing the dataset's characteristics, the prediction task, and associated domain knowledge will allow the CAAFE system to utilize a language model(s) to generate code that defines new (and potentially meaningful) features.

The CAAFE system 100 itself comprises four key components: (1) an LLM 104 that generates executable code defining new features, as guided by a context-aware prompt; (2) an interpreter modules that executes the LLM-generated code; (3) a validation module 108 that evaluates the impact of these features on model performance and selectively retains them; and (4) an iterative feedback loop 110 that progressively enriches the dataset with retained features and triggers further rounds of feature generation.

Turning now to block 104, CAAFE may utilize an LLM (e.g., such as the GPT-family of language models) that is explicitly guided by natural language descriptions of the dataset and task (e.g., from block 102). This allows the LLM to understand semantic context and generate executable code snippets (e.g., Python code) for new, potentially complex features that capture domain-specific insights that would often be missed by traditional, i.e., context-agnostic, automated methods. According to some embodiments, the LLM may also be configured to generate natural language explanations for these features, thus aiding greatly in the interpretability of the generated features.

At block 106, an interpreter module then executes the LLM-generated code to augment the dataset with the corresponding feature values. For example, if the LLM determines that tabular data column values, such as “height” and “weight” could be combined in a mathematically meaningful and useful way to create a new data category, such as body-mass index (BMI), then the interpreter at block 106 could compute and augment the dataset with a new “BMI” column for each record in the dataset, i.e., based on combining the corresponding height and weight values for each record in a contextually-appropriate mathematical fashion, which BMI column could then be used to improve the efficacy of the prediction task at hand.

A validation module 108 may then execute the generated code to compute new data features, evaluate the impact of these new data features on the performance of a machine learning model, and selectively retain new data features based on a performance improvement criterion. Evaluating the impact of the new features on the performance of a machine learning model may involve using appropriate performance metrics. For example, features resulting in a significant improvement are retained, while those that do not are discarded. The CAAFE system 100 may then update the dataset with the retained new data features (e.g., the aforementioned “BMI” feature) and repeat the generate-evaluate-update process for a specified number of iterations (or until the performance improvement gains diminish below a set threshold). Once completed, the CAAFE system 100 may output the final dataset, i.e., as enhanced with the newly-engineered features that have been iteratively refined and validated as being useful to the prediction task at hand. In some embodiments, the explanations and code used to generate the features can also be retrieved form the CAAFE system 100 to aide interpretability, if so desired.

As discussed above, CAAFE system 100 may comprise the use of an iterative feedback loop 110 that iteratively incorporates the retained features into the dataset and recursively re-submits the augmented dataset to the language model for additional rounds of feature generation. This iterative loop process 110 may continue until a performance enhancement threshold is no longer met. In other words, the CAAFE system 100 incorporates a closed loop evaluation process, wherein the generated feature code is executed, and each feature's actual utility is measured by its impact on a downstream ML model's performance, e.g., using standard techniques like validation (e.g., measuring the Area Under the Receiver Operating Characteristic curve, or “ROC AUC” score). Then, only the features that demonstrably improved the task performance above a threshold amount are retained. This technique grounds the LLM's generative capabilities in empirical evidence, thereby bridging the gap between creative feature ideation and robust machine learning practice.

As may now be appreciated, the CAAFE systems disclosed herein streamline feature engineering by automating the discovery of complex, semantically meaningful features that are closely aligned with the specific characteristics and objectives of the dataset. The iterative refinement process ensures the generation of an optimized feature set that enhances model performance while maintaining interpretability. By dynamically integrating domain knowledge into feature creation and continuously validating feature relevance, these techniques offer substantial efficiency and performance improvements over manual and existing automated methods. They also reduce computational overhead, adapt to diverse data types and prediction tasks, and unlock the full potential of LLMs in AutoML.

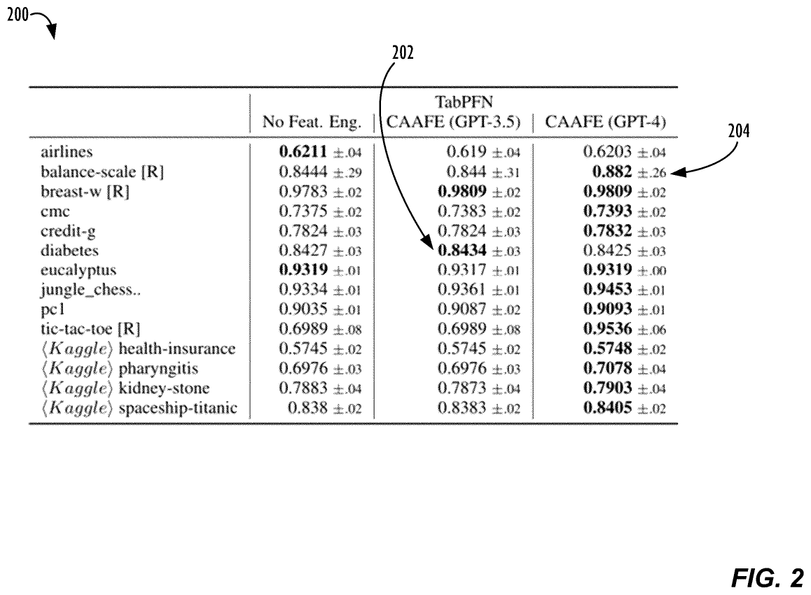

Turning now to FIG. 2, a table 200 is illustrated, comparing the performance of a CAAFE system across various datasets, according to one or more embodiments of the present disclosure. Specifically, table 200 displays the comparative performance of CAAFE versus traditional methods without feature engineering and with other LLM models. It highlights the significant improvements in ROC AUC across multiple datasets, using a predictive model specifically optimized for tabular data, referred to here as TabPFN. For example, arrow 202 shows that the TabPFN model using a CAAFE system (leveraging GPT-3.5 as its LLM) scored a 0.8434 ROC AUC on the ‘diabetes’ dataset, as compared to 0.8427 when no feature engineering was used. As another example, arrow 204 shows that the TabPFN model using a CAAFE system (leveraging GPT-4 as its LLM) scored a 0.882 ROC AUC on the ‘balance-scale [Reduced]’ dataset, as compared to 0.8444 when no feature engineering was used. The other rows in table 200 show that using a CAAFE system (leveraging GPT-4 as its LLM) generally results in a higher ROC AUC score on nearly all of the exemplary datasets.

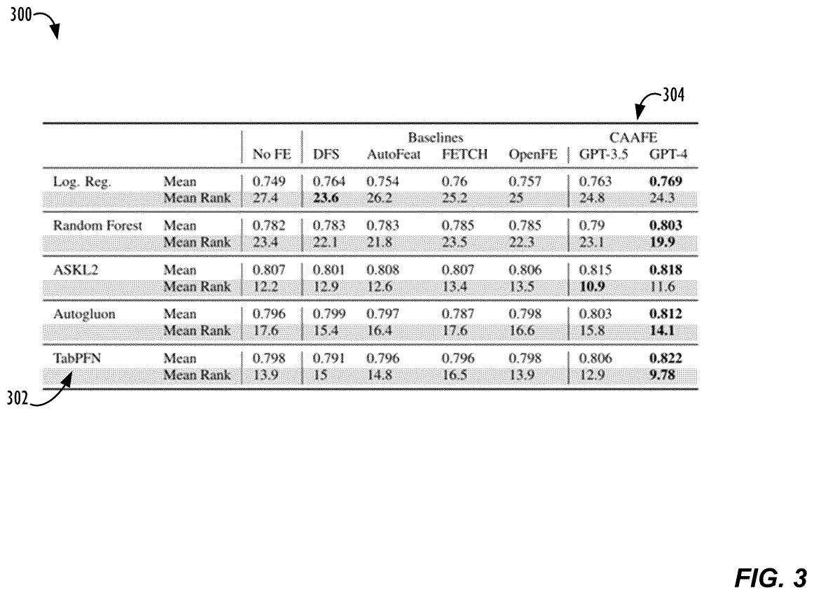

Turning now to FIG. 3, a table 300 is illustrated, comparing a CAAFE system with existing feature engineering methods, according to one or more embodiments of the present disclosure. To validate the effectiveness of CAAFE, extensive experiments were conducted, using diverse tabular datasets, e.g., sourced from OpenML and Kaggle. The datasets span various domains and include both classification and regression tasks. For each dataset, a natural language description was provided to the LLM, capturing the relevant context and domain knowledge for the respective datasets. CAAFE was then applied to generate context-aware features using both GPT-3.5 and GPT-4 as the underlying language models. The impact of these features was evaluated using several machine learning models, including logistic regression, random forests, and a state-of-the-art tabular learning model called TabPFN (shown at row 302).

Table 300 provides a comparative analysis of CAAFE (shown in column 304) against prior automated feature engineering methods, such as Deep Feature Synthesis (DFS), AutoFeat, FETCH, and OpenFE. It quantifies performance using state-of-the-art prediction methods and illustrates the superior capability of CAAFE in integrating domain-specific knowledge to enhance feature engineering outcomes. In fact, the experimental results shown in table 300 demonstrate that CAAFE consistently improves the predictive performance across the diverse set of datasets and models. For example, with GPT-4 as the language model, CAAFE improved the mean ROC AUC of TabPFN from 0.798 to 0.822 (shown at row 302), with performance gains observed on 11 out of the 14 datasets of FIG. 2. This improvement is comparable to the gains achieved by using a more complex model, such as a random forest model versus a simple linear model.

Notably, CAAFE's generated features were able to enhance performance even on then-newer Kaggle datasets, which were unlikely to have been part of the language models' pre-training data. This underscores CAAFE's ability to generalize and generate meaningful features on unseen datasets. In addition to the quantitative performance gains, CAAFE may also be configured to generate human-interpretable explanations for each engineered feature, thereby providing additional insights into the reasoning behind the generated features and data transformations. This interpretability is crucial for building trust and facilitating the adoption of automated feature engineering techniques in real-world applications.

### Exemplary Methods for Performing Context-Aware Automated Feature Engineering (CAAFE)

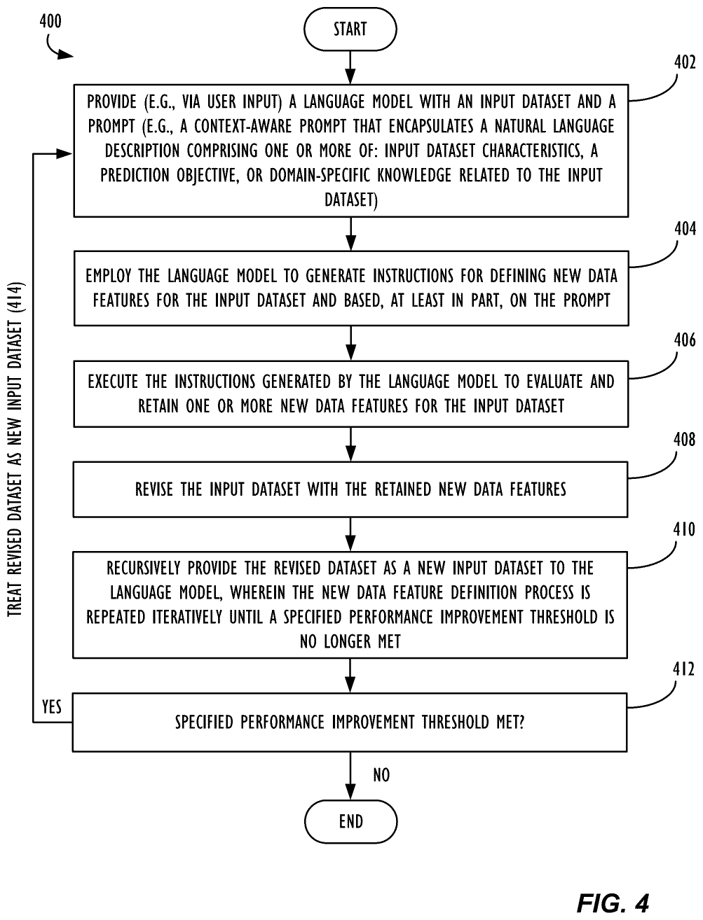

FIG. 4 illustrates an exemplary flow chart for a process 400 for using a CAAFE system. First, at step 402, the method 400 may provide (e.g., via user input) a language model (e.g., an LLM) with an input dataset and a prompt (e.g., a context-aware prompt that encapsulates a natural language description comprising one or more of: input dataset characteristics, a prediction objective, or domain-specific knowledge related to the input dataset).

Next, at step 404, the method 400 may employ the language model to generate instructions for defining new data features for the input dataset and based, at least in part, on the prompt.

Next, at step 406, the method 400 may execute the instructions generated by the language model to evaluate and retain one or more new data features for the input dataset.

Next, at step 408, the method 400 may revise (e.g., via an iterative feedback loop) the input dataset with the retained new data features.

Next, at step 410, the method 400 may recursively provide the revised dataset as a new input dataset to the language model, wherein the new data feature definition process is repeated iteratively until a specified performance improvement threshold is no longer met.

As shown at step 412, if the specified performance improvement threshold is still being met by the most recently-revised version of the dataset (i.e., “YES” at step 412), the method 400 may return to step 402, while treating the most recently-revised version of the dataset as the new input dataset (as shown by line 414), and then proceeding on to step 404 et seq. to iteratively repeat the new data feature definition process on the revised dataset.

By contrast, as shown at step 412, if the specified performance improvement threshold is no longer met by the most recently-revised version of the dataset (i.e., “NO” at step 412), the method 400 may end, and no further automated data feature generation processes will be performed on the dataset.

It is to be understood that FIG. 4 is merely exemplary and that, in other implementations, additional or fewer steps may be performed, and one or more steps may be performed in a different sequence. For example, in some implementations, the method 400 may include the parallel execution and/or merging of multiple distinct feature engineering hypotheses or workflows within the system. In still other implementations, different statistical tests may be employed to determine the significance threshold for including generated features, e.g., rather than solely checking for whether a specified performance improvement threshold is met. In yet other implementations, the system may be adapted to leverage information from multiple related input datasets simultaneously to improve feature generation for a primary target dataset. In still other implementations, the method 400 may include browsing the Internet for additional data sources and/or domain knowledge during the iterative feedback process. These techniques may also be used for regression data (i.e., as opposed to purely classification tasks).

### Experimental Results

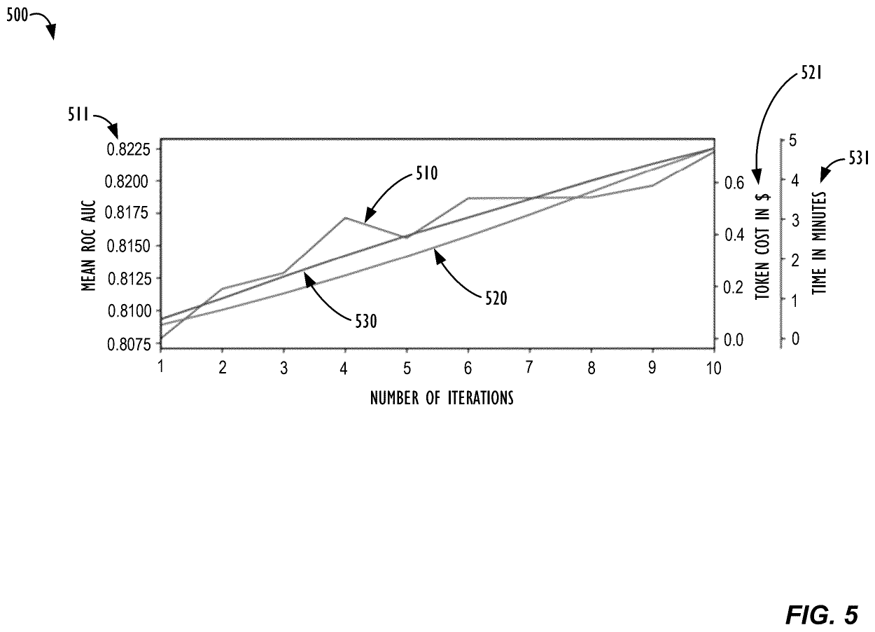

Turning now to FIG. 5, a graph 500, illustrating various efficiency metrics of a CAAFE system over a number of iterative steps is shown, according to one or more embodiments of the present disclosure. The graph 500 tracks three exemplary efficiency metrics—accuracy (i.e., line 510/axis 511), execution cost (i.e., line 520/axis 521), and time (i.e., line 530/axis 531)—of the CAAFE system through an increasing number of iterative steps (here, from 1 up to 10 iterative steps).

Graph 500 shows a generally linear increase in all metrics with repeated iterations, underscoring the system's efficiency and effectiveness. The graph 500 also includes a comparison point, showing the performance of CAAFE without the iterative mechanism, represented as the initial step (i.e., NUMBER OF ITERATIONS=1). It is to be understood that the illustration of ten iterations in graph 500 is merely illustrative, and that more iterations could be applied in a given implementation, e.g., based on whether increased accuracy is desired and/or possible within given cost/time constraints for the given implementation, etc.

Graph 500 also illustrates that also exhibits strong computational efficiency. In this example, on average, CAAFE took 4 minutes and 43 seconds to process each dataset, with 90% of the time spent on feature generation using the language model and 10% on evaluating the impact of the features using TabPFN (as opposed to baseline/prior art approaches for feature engineering, which can take up to an hour on the same datasets). This efficiency enables the practical application of CAAFE to real-world datasets. Furthermore, CAAFE seamlessly integrates with existing automated feature engineering libraries, such as Deep Feature Synthesis (DFS) and AutoFeat. Applying these libraries to the CAAFE-augmented datasets leads to additional performance improvements, thereby highlighting the complementary nature of the techniques.

As may now be appreciated, CAAFE introduces a powerful and novel approach for automating feature engineering by leveraging the capabilities of large language models. The context-awareness, interpretability, iterative refinement, flexibility, and efficiency of CAAFE offers significant advantages over manual feature engineering and existing automated techniques.

Moreover, by systematizing the incorporation of domain knowledge and enabling the discovery of complex features, CAAFE has the potential to greatly accelerate and enhance the development of machine learning applications for tabular data. The experimental results confirm the effectiveness of CAAFE across a diverse range of datasets, prediction tasks, and evaluation models. The consistent performance improvements, interpretability of the generated features, and computational efficiency establish CAAFE as a valuable tool in the AutoML ecosystem. As such, CAAFE represents a significant step towards the goal of automating the end-to-end data science pipeline and democratizing the development of high-performance machine learning solutions.

### Exemplary Electronic Device

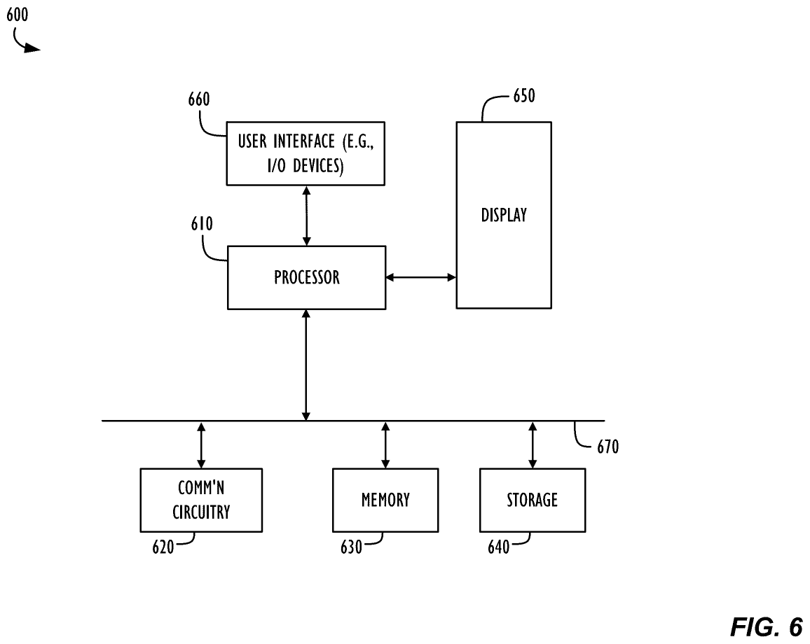

Referring now to FIG. 6, a simplified functional block diagram of an illustrative multifunctional electronic device 600 for use in implementing a CAAFE system, according to various aspects of the disclosure, is shown. Multifunction electronic device 600 may include processor 610, memory 630, storage device 640, user interface 660, display 650, communications circuitry 620 (e.g., radios, antenna, network interface cards, etc.), and communications bus 670. Multifunction electronic device 600 may be, for example, a personal electronic device such as a personal digital assistant (PDA), mobile telephone, or a tablet computer.

Processor 610 may execute instructions necessary to carry out or control the operation of many functions performed by device 600. Processor 610 may, for instance, drive display 650 and receive user input from user interface 660. User interface 660 may allow a user to interact with device 600. For example, user interface 660 can take a variety of forms, such as a button, keypad, dial, a click wheel, keyboard, display screen and/or a touch screen. Processor 610 may also, for example, be a system-on-chip such as those found in mobile devices and include a dedicated graphics processing unit (GPU). Processor 610 may be based on reduced instruction-set computer (RISC) or complex instruction-set computer (CISC) architectures or any other suitable architecture and may include one or more processing cores.

Memory 630 may include one or more different types of media used by processor 610 to perform device functions. For example, memory 630 may include memory cache, read-only memory (ROM), and/or random access memory (RAM). Storage 640 may store media (e.g., audio, image and video files), computer program instructions or software, preference information, device profile information, and any other suitable data. Storage 640 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 630 and storage 640 may be used to tangibly retain computer program instructions or code organized into one or more modules and written in any desired computer programming language. When executed by, for example, processor 610, such computer program code may implement one or more of the methods described herein.

While systems and methods have been described in connection with the various embodiments of the various figures, it will be appreciated by those skilled in the art that changes could be made to the embodiments without departing from the broad inventive concept thereof. It is understood, therefore, that this disclosure is not limited to the particular embodiments disclosed, and it is intended to cover modifications within the spirit and scope of the present disclosure as defined by the claims.

What is claimed is:

1. A system for automated feature engineering, comprising:
a language model configured to generate instructions for defining new data features for an input dataset based on a prompt;
a validation module configured to execute the instructions generated by the language model to evaluate and retain one or more new data features for the input dataset; and
an iterative feedback loop configured to revise the input dataset with the retained new data features and recursively provide the revised dataset as a new input dataset to the language model,
wherein the new data feature definition process is repeated iteratively until a specified performance improvement threshold is no longer met.

2. The system of claim 1, wherein the prompt is a context-aware prompt.

3. The system of claim 1, wherein the prompt encapsulates a natural language description comprising one or more of: input dataset characteristics, a prediction objective, or domain-specific knowledge related to the input dataset.

4. The system of claim 1, wherein the language model is based on any pre-trained model capable of processing and generating natural language instructions.

5. The system of claim 1, wherein the evaluation of the one or more new data features is based, at least in part, on an effect of the one or more new data features on a performance of a data processing model.

6. The system of claim 5, wherein the data processing model comprises one or more of: a statistical model; a machine learning model; or a deep learning network.

7. The system of claim 1, wherein the validation module is further configured to retain new data features based, at least in part, on a performance improvement criterion being met.

8. The system of claim 7, wherein the performance improvement criterion comprises one or more of: a statistical metric; or a machine learning performance metric.

9. A method for automated feature engineering, comprising:
providing a language model with an input dataset and a prompt;
employing the language model to generate instructions for defining new data features for the input dataset and based, at least in part, on the prompt;
executing the instructions generated by the language model to evaluate and retain one or more new data features for the input dataset;
revising the input dataset with the retained new data features; and
recursively providing the revised dataset as a new input dataset to the language model, wherein the new data feature definition process is repeated iteratively until a specified performance improvement threshold is no longer met.

10. The method of claim 9, wherein the prompt encapsulates a natural language description comprising one or more of: input dataset characteristics, a prediction objective, or domain-specific knowledge related to the input dataset.

11. The method of claim 9, wherein the language model is based on any pre-trained model capable of processing and generating natural language instructions.

12. The method of claim 9, wherein the evaluation of the one or more new data features is based, at least in part, on an effect of the one or more new data features on a performance of a data processing model.

13. The method of claim 12, wherein the data processing model comprises one or more of: a statistical model; a machine learning model; or a deep learning network.

14. The method of claim 9, wherein the retaining of one or more new data features further comprises: retaining new data features based, at least in part, on a performance improvement criterion being met.

15. A non-transitory program storage device (NPSD) comprising instructions stored thereon that, when executed, cause a computer to:
provide a language model with an input dataset and a prompt;
employ the language model to generate instructions for defining new data features for the input dataset and based, at least in part, on the prompt;
execute the instructions generated by the language model to evaluate and retain one or more new data features for the input dataset;
revise the input dataset with the retained new data features; and
recursively provide the revised dataset as a new input dataset to the language model, wherein the new data feature definition process is repeated iteratively until a specified performance improvement threshold is no longer met.

16. The NPSD of claim 15, wherein the prompt encapsulates a natural language description comprising one or more of: input dataset characteristics, a prediction objective, or domain-specific knowledge related to the input dataset.

17. The NPSD of claim 15, wherein the language model is based on any pre-trained model capable of processing and generating natural language instructions.

18. The NPSD of claim 15, wherein the evaluation of the one or more new data features is based, at least in part, on an effect of the one or more new data features on a performance of a data processing model.

19. The NPSD of claim 18, wherein the data processing model comprises one or more of: a statistical model; a machine learning model; or a deep learning network.

20. The NPSD of claim 15, wherein the retaining of one or more new data features further comprises: retaining new data features based, at least in part, on a performance improvement criterion being met.
